(19) United States
(12) Patent Application Publication
(10) Pub. No.: US 2009/0092243 A1
(43) Pub. Date: Apr. 9, 2009

(54) Protection Circuit and Method

(75) Inventors: Octavian Mitrea, Klagenfurt (AT); Thomas Ferianz, Bodensdorf (AT); Joachim Pichler, Landskron (AT)

Correspondence Address: BANNER & WITCOFF, LTD.;Attorneys for client 007052, 1100 13th STREET, N.W., SUITE 1200, WASHINGTON, DC, 20005-4051, US

(73) Assignee: INFINEON TECHNOLOGIES AG, Neubiberg (DE)

(21) Appl. No.: 11/869,389

(22) Filed: Oct. 9, 2007

(51) Int. Cl. H04M 19/00; H02H 3/00; H04M 9/00

(52) U.S. Cl. 379/412; 340/662; 361/88

(57) ABSTRACT

Apparatuses and methods for coupling a voltage supply input of an interface circuit of a communication device to a reference potential in response to at least one of an over-voltage and an over-current occurring in a communication line.

### BACKGROUND

In communication devices, interface circuits are used to terminate communication lines, said communication lines serving to connect different communicating entities with each other. For example, in so called central office equipment of telephone communication systems or DSL (digital subscriber line) communication systems, subscriber line interface circuits (SLICs) are used to terminate communication lines connecting the central office equipment with subscribers of the respective communication service, for example with private homes, companies and the like.

In such communication systems, communication lines may for example be struck by lightning and/or be accidentally connected to power lines, which can lead to the occurrence of excessive voltages and/or currents on the communication lines. Such voltages and currents may in turn damage the interface circuits mentioned above or other communication circuits connected to the communication lines.

Therefore, there is a need for protection circuits protecting communication circuits from being damaged by excessive voltages or currents on communication lines.

### SUMMARY

Some aspects as disclosed herein are directed to apparatuses and methods for coupling a voltage supply input of an interface circuit of a communication device to a reference potential in response to at least one of an over-voltage and an over-current occurring in a communication line.

These and other aspects of the disclosure will be apparent upon consideration of the following detailed description of illustrative aspects.

### BRIEF DESCRIPTION OF THE DRAWINGS

Various illustrative embodiments will be explained below with reference to figures. In the figures, unless otherwise stated, identical reference symbols denote the same circuit components and signals with the same meaning.

FIG. 1 is a functional block diagram of an illustrative embodiment of a communication device.

FIG. 2 is a schematic diagram of an illustrative embodiment of a communication device.

FIG. 3 is a functional block diagram showing a portion of an illustrative embodiment of a communication device.

### DETAILED DESCRIPTION

In the following, illustrative embodiments of the present invention will be described in detail. It is to be understood that the following description is given only for the purpose of illustration and is not to be taken in a limiting sense. The scope of the invention is not intended to be limiting by the illustrative embodiments described hereinafter.

It is also to be understood that in the following description of illustrative embodiments, any direct connection or coupling between functional blocks, devices, components, circuit elements or other physical or functional units shown in the drawings or described herein could also be implemented by an indirect connection or coupling, for example a connection or coupling comprising one or more intervening elements. Furthermore, it should be appreciated that functional blocks or units shown in the drawings may be implemented as separate circuits, but may also be fully or partially implemented in a common circuit.

It is further to be understood that the features of the various illustrative embodiments described herein may be combined with each other unless specifically noted otherwise.

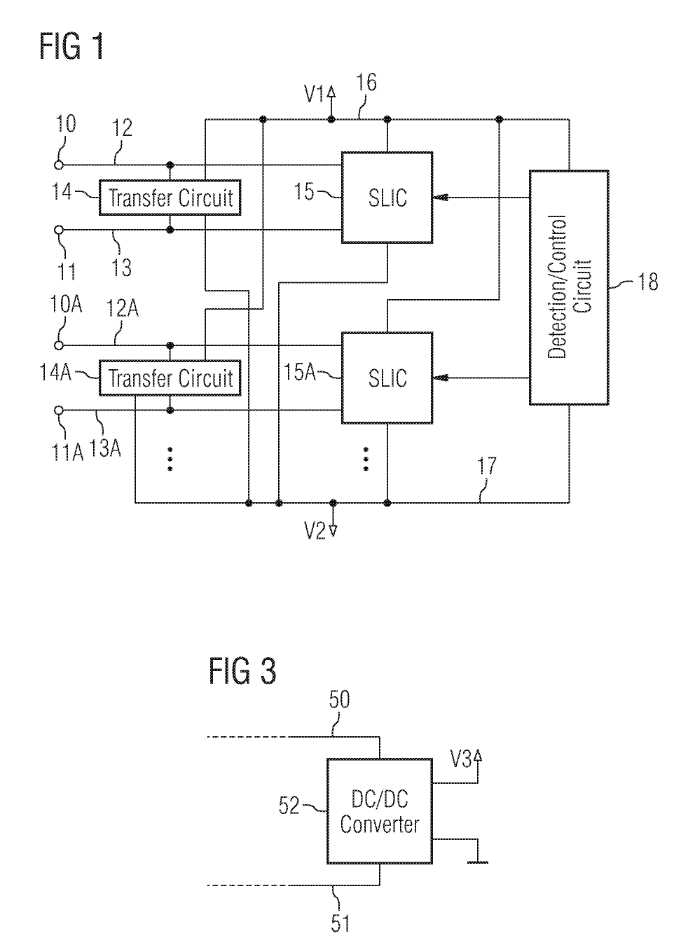

In FIG. 1, an illustrative embodiment of a communication device is shown. The embodiment shown in FIG. 1 may for example be implemented as a line card used in central office equipment to terminate a plurality of communication lines, such as subscriber lines, connecting the central office with subscribers of a communication service like telephone communication or digital subscriber line (DSL) communication. However, it may also be implemented in so-called customer's premises, i.e. at the location of a subscriber.

The communication device of the embodiment of FIG. 1 comprises a number of subscriber line interface circuits (SLICs) of which two SLICs 15, 15A are shown in FIG. 1. However, as indicated by dots in FIG. 1 any number of SLICs starting with a single SLIC may be used as desired, the number of which may depend on the number of subscriber lines to be connected with the communication device.

SLIC 15 is connected with inputs 10, 11 via lines 12, 13, wherein inputs 10, 11 serve as inputs for a communication line comprising two wires, for example a tip line and a ring line in case of telephone networks and the like. In another embodiment, instead of two inputs to be connected to two wires for receiving differential signals, a single input to be connected to a single wire for transmitting single ended signals may be provided.

Likewise, SLIC 15A is connected via lines 12A, 13A with inputs 10A, 11A to which a further communication line comprising two wires like a tip line and a ring line may be connected.

SLICs 15, 15A are each coupled to a first voltage supply line 16 which is supplied with a first supply voltage V1 and a second voltage supply line 17 which is connected to a second supply voltage V2. First and second voltage supply lines 16, 17 are examples for power supply lines for a communication circuit.

The communication device of FIG. 1 comprises a protection circuit to protect SLICs 15, 15A against over-voltages on communication lines coupled with inputs 10, 11 and 10A, 11A, respectively. An over-voltage generally refers to a voltage exceeding a predetermined threshold, for example exceeding a nominal operating voltage.

This protection circuit in the embodiment of FIG. 1 comprises a transfer circuit 14 coupled between lines 12 and 13, a transfer circuit 14A coupled between lines 12A and 13A, and a detection and control circuit 18. In case more than two SLICs are provided in the communication device, correspondingly more than two transfer circuits may be provided. However, in another embodiment transfer circuits may also be provided only for some of the SLICs.

Since in the embodiment of FIG. 1 the function of transfer circuit 14A corresponds to the function of transfer circuit 14, only transfer circuit 14 will be described in the following in detail. Transfer circuit 14 as shown in FIG. 1 is coupled with inputs 10, 11 via lines 12, 13 on the one hand and with voltage supply lines 16, 17 on the other hand. In normal operation, i.e. without any over-voltage present at inputs 10, 11, transfer circuit 14 is in a high impedance state and basically does not influence the operation of the communication device. Over-voltage in this respect may for example designate a voltage outside a nominal voltage range of inputs 10, 11. In case such an over-voltage occurs on inputs 10, 11, for example when lightening strikes a communication line coupled with inputs 10, 11, transfer circuit 14 becomes at least partially conducting and diverts the over-voltage to voltage supply lines 16 and/or 17.

This in turn changes the voltage on voltage supply lines 16 and 17. In the embodiment of FIG. 1, detection and control circuit 18 is adapted to detect the voltage change. To this end, in an embodiment detection and control circuit 18 may comprise one or more comparators comparing the voltage on voltage supply lines 16, 17 with the respective nominal voltages V1, V2 or other predetermined threshold voltages. If detection circuit 18 detects such a voltage change caused by over-voltage on voltage supply line 16 and/or voltage supply line 17, in the embodiment of FIG. 1 detection and control circuit 18 controls one or more of SLICs 15, 15A to sink the over-voltage for example to ground, for example by internally connecting voltage supply line 16 and/or voltage supply line 17 to ground. In some embodiments, all of the SLICs may be controlled to be switched to such a “sink mode” where the over-voltage on voltage supply lines 16, 17 is reduced via SLICs 15, 15A. In further embodiments, only inactive SLICs, i.e. SLICs which do not have an active communication line connected to them, are switched to sink mode. Other combinations of SLICs to be switched to sink mode are also envisioned.

In some embodiments, V1 and V2 are battery voltages. As already mentioned, in some embodiments, tip lines of corresponding communication lines may be connected to inputs 10, 10A, whereas ring lines may be connected to inputs 11, 11A.

It should be noted that the protection circuit of the embodiment of FIG. 1 may be used alone, but also in combination with further protection elements. For example, in some embodiments the protection circuit comprising transfer circuits 14, 14A and detection circuit 18 may serve as a secondary protection, whereas a primary over-voltage protection, for example a gas discharge tube, may be additionally provided. In some embodiments, such a primary over-voltage protection is provided exterior to a line card, for example in a main distribution frame (MDF) of a building where the communication device of FIG. 1 is located. Furthermore, further elements for protection against over-currents, i.e. against excessive currents which may for example occur when communication lines are accidentally connected to power supplies, may be provided.

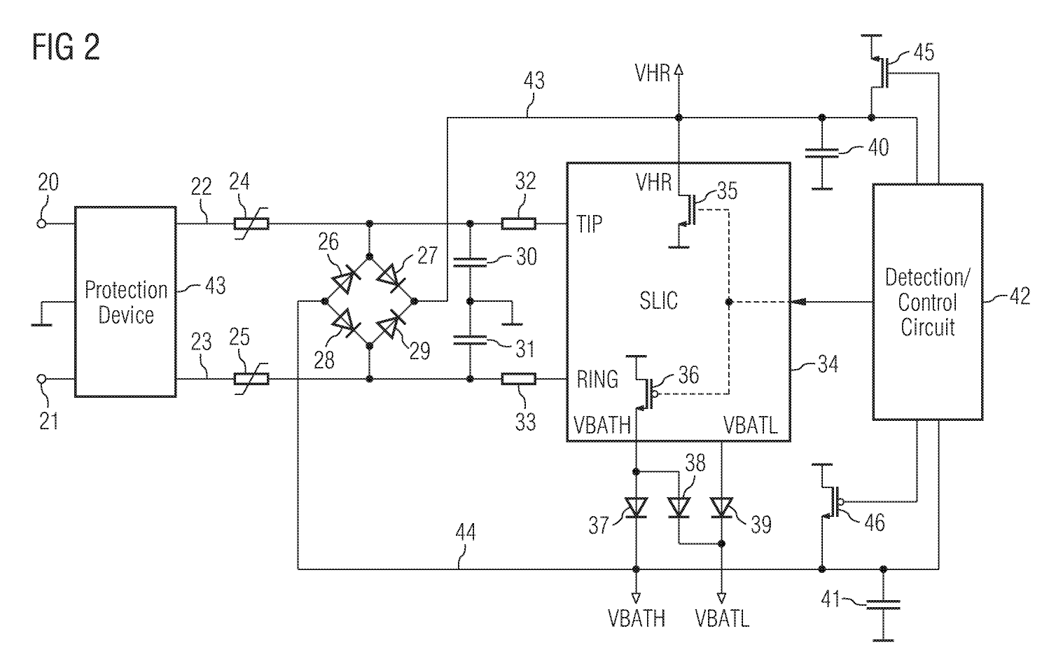

As already mentioned, the communication device of FIG. 1 may be implemented as a line card. In such a case, a single detection circuit 18 may be provided controlling all SLICs on the line card, or more than one detection circuit may be provided. A communication device according to another illustrative embodiment will next be described with reference to FIG. 2. The embodiment shown in FIG. 2 may be realized independently from the embodiment shown in FIG. 1, but may also serve as an example for implementing transfer circuits 14, 14A of the embodiment of FIG. 1 and as an example for further elements which may be added to the embodiment of FIG. 1.

In the embodiment of FIG. 2, inputs 20, 21 are provided to be connected to a communication line, for example tip line and ring line of a telephone communication line. A primary protection device 43 is coupled between a line 22 which is connected with input 20 and a line 23 which is connected with input 21. Primary protection device 43 may for example be a gas discharge tube which shunts an over-voltage occurring at inputs 20, 21 to ground. Primary protection device 43 for example may be located in a main distribution frame (MDF) of a building where the communication device of the embodiment of FIG. 2 is located, whereas the remaining components shown in FIG. 2 for example may be implemented as a line card or be implemented in a separate communication device.

In the embodiment of FIG. 2, in line 22 a positive temperature coefficient (PTC) thermistor 24 is provided, and in line 23 a PTC thermistor 25 is provided. Such PCT thermistors exhibit a rapidly rising resistance with rising temperature the significance of which will be explained later.

Furthermore, in the embodiment of FIG. 2, a diode bridge comprising diodes 26, 27, 28 and 29 is coupled between lines 22, 23 and furthermore coupled to voltage supply lines 43, 44. The diode bridge comprising diodes 26-29 may serve as an example of the transfer circuit 14 as explained with reference to FIG. 1. In some embodiments, diodes 26-29 are chosen such that their maximum reverse voltage is higher than the associated supply voltage associated with the diode, i.e. the supply voltage present on voltage supply line 43 or voltage supply line 44. In some embodiments, the diode bridge has a maximum reverse voltage of at least 100 V (or in other embodiments, at least 200 V), an average rectified current of at least 0.25 A, (or in other embodiments, at least 0.5 A), and a maximum peak current of at least 20 A (or in other embodiments, at least 35 A). In still further embodiments, other values are possible.

In the embodiment of FIG. 2, line 22 is coupled with a tip input, i.e. an input to be coupled to a tip line of a SLIC 34 via an input resistor 32, and line 23 is coupled with a ring input of SLIC 34 via an input resistor 33. In some embodiments, input resistors 32, 33 each have resistances of approximately 50Ω, although other values are possible. Furthermore, input capacitances 30, 31 coupled to lines 22 and 23, respectively, on the hand and to ground on the other hand, are provided in the embodiment of FIG. 2.

In the embodiment of FIG. 2, voltage supply line 43 is coupled with a supply voltage VHR (voltage high ringing) which in the embodiment of FIG. 2 is a positive voltage which for example may have a value of +32 V with respect to ground. Such a voltage may for example be used in “ringing mode” in case of a SLIC for telephone circuits.

Voltage supply line 43 is coupled with a corresponding input labeled VHR of SLIC 34.

Voltage supply line 44 is coupled to a voltage VBATH (battery voltage high) which in the embodiment of FIG. 2 is the most negative supply voltage and may for example have a value of −48 V with respect to ground. In an embodiment, when voice signals are transmitted via a communication line coupled with inputs 20 and 21, SLIC 34 is operated between VBATH and ground. Voltage supply line 44 is connected with a corresponding supply voltage input labeled VBATH of SLIC 34 via a diode 37. Furthermore, a voltage input labeled VBATL of SLIC 34 is coupled with a corresponding supply voltage VBATL (battery voltage low) which is a negative voltage which for example may have a value of −24 V with respect to ground. The provision of this voltage is purely optional. This voltage in some embodiments may be used for short communication lines where it is not necessary to use VBATH. A diode 39 is provided via which a corresponding voltage input of SLIC 34 is coupled with voltage VBATL. Furthermore, in the embodiment of FIG. 2 a diode 38 is provided via which the voltage input for VBATH of SLIC 34 is also coupled with VBATL. Voltage supply lines 43, 44 serve as power rails or lines for the communication device of FIG. 2.

In the embodiment shown in FIG. 2, furthermore voltage supply line 43 is coupled with ground via a capacitor 40, and voltage supply line 44 is coupled with ground via a capacitor 41. In some embodiments, capacitors 40, 41 may be output capacitors of one or more direct current (DC)/DC converters (not shown) used for example for providing the supply voltages VHR, VBAT, VBATL and the like in the communication device, for example a line card. In further embodiments, capacitors 40 and 41 are dedicated capacitors which are provided separately. In some embodiments, capacitors 40, 41 have a capacitance of at least 100 μF, for example 200 μF. However, other values are possible as well.

In the embodiment of FIG. 2, supply line 43 is coupled with ground via one or more negative channel metal-oxide-semiconductor (N-channel MOS, or NMOS) transistors 45, and voltage supply line 44 is coupled with ground via one or more positive channel metal-oxide-semiconductor (P-channel MOS, or PMOS) transistors 46. In the embodiment of FIG. 2, furthermore a detection circuit 42 similar to detection and control circuit 18 explained with reference to FIG. 1 is provided which, in the embodiment of FIG. 2, controls the gates of MOS transistors 45, 46 and furthermore controls SLIC 34 in case of an over-voltage as will be explained further below in greater detail.

It should be noted that the embodiment shown in FIG. 2 merely serves as a further example, and various modifications are possible. For instance, MOS transistors 45, 46 in some embodiments may be omitted. Also, similar to the embodiment of FIG. 1, a plurality of SLICs to be connected to a plurality of communication lines may be provided. In further embodiments, voltage VBATL may be omitted. These examples for modifications are not exhaustive, and further modifications are possible.

Next, the operation of the communication device of FIG. 2 regarding protection of SLIC 34 against over-voltages and over-currents at inputs 20, 21 will be described.

An over-current, i.e. a current exceeding a predetermined threshold, may for example be generated if a communication line coupled to input 20, 21 accidentally is coupled to a power source. In this case, the input current supplied to inputs 20, 21 is clamped by the diode bridge comprising diode 26-29 to voltage supply lines 43, 44. Accordingly, capacitor 40 and/or capacitor 41 is charged.

The voltage on voltage supply lines 43, 44 is detected by detection circuit 42. If the voltage on voltage supply line 43 and/or the voltage on voltage supply line 44 exceeds a predetermined reference voltage through the clamping of the over-current described above, detection circuit 42 sends a corresponding control signal to SLIC 34 to put SLIC 34 into a “sink mode”. This for example may be achieved by controlling gates of an internal NMOS transistor 35 and an internal PMOS transistor 36 of SLIC 34 to put MOS transistors 35 and 36 to a conducting state coupling the input for supply voltages VAR, VBATH of SLIC 34 to ground. However, MOS transistors 35, 36 serve only as examples, and other switch elements may also be used to couple the corresponding supply voltage input to ground or another reference voltage.

In case additional MOS transistors 45, 46 are provided as in FIG. 2, these are also controlled to be conducting therefore providing an additional path from voltage supply lines 43, 44 to ground. It should be noted that a predetermined threshold value for putting SLIC 34 to sink mode may be different from a predetermined threshold voltage on which the control of MOS transistors 45 and 46 is based. In other words, when a voltage on voltage supply lines 43, 44 rises, in an embodiment SLIC 34 may be put to power sink mode and MOS transistors 45, 46 may be put to a conducting state when the same predetermined threshold voltage is reached, or, in another embodiment, SLIC 34 may be put into power sink mode when a first threshold voltage is reached, and transistors 45, 46 may be switched to a conducting state when a second threshold voltage is reached, said first threshold voltage being smaller or greater than said second threshold voltage.

Furthermore, as already explained with respect to the embodiment of FIG. 1, in case a plurality of SLICs like SLIC 34 are provided in a communication device, in some embodiments only some of the SLICs may be switched to sink mode, for example only SLICs connected with inactive communication lines.

In case of a prolonged over-current, PTC thermistors 24, 25 are heated by the current switching them to a non-conducting state and therefore effectively decoupling SLIC 34 from inputs 20, 21.

In case of a short term over-voltage or surge as for example induced by lightening striking a communication line coupled with inputs 20, 21, the corresponding input signal applied to inputs 20, 21 which is a pulse in this case is again transferred via the diode bridge to voltage supply lines 43, 44 and therefore to capacitors 40, 41. In some embodiments, these capacitors 40, 41 are dimensioned such that a maximum allowable bias value for SLIC 34 is not exceeded. When because of the input pulse, the voltage on voltage supply lines 43, 44 changes, and exceeds a predetermined threshold value, detection circuit 42 again puts SLIC 34 in power sink mode and/or puts MOS transistors 45, 46 in a conducting state to discharge capacitances 40, 41 to the nominal bias values of voltage supply lines 43, 44.

In addition, the current which flows because of the input pulse in the embodiment of FIG. 2 generates a voltage drop on PTC thermistors 24, 25 which biases the primary protection device 43. From this point on, primary protection device 43 shunts the remaining charge to ground. Due to the shortness of such pulses, in such a case thermistors 24, 25 generally may not be expected to switch to their non-conducting state.

Similar to the detection circuit 18 of the embodiment of FIG. 1, detection circuit 42 may comprise one or more comparators comparing the voltage on voltage supply lines 43, 44 with one or more predetermined reference voltages.

In FIG. 3, a portion of a communication device according to a further embodiment of the present invention is shown. The embodiment shown in FIG. 3 may for example be implemented as a modification of the embodiment of FIG. 1 or FIG. 2.

In FIG. 3, two voltage supply lines 50, 51 are shown which for example may correspond to voltage supply lines 16, 17 of the embodiment of FIG. 1 or to voltage supply lines 43, 44 of the embodiment of FIG. 2. A voltage on these voltage supply lines in the embodiment of FIG. 3 is generated by one or more DC/DC converters 52 based on a supply voltage V3 with respect to ground.

In some embodiments, DC/DC converter 52 is a reversible DC/DC converter, for example a two or four quadrant DC/DC converter.

In some embodiments, DC/DC converter 52 comprises a detection circuit configured to detect an over-voltage on voltage supply lines 50, 51 similar to the detection already described with reference detection circuits 18, 42 of FIGS. 1 and 2. In case an over-voltage is detected, DC/DC converter 52 sinks or sources the external current such that the supply voltages on voltage supply lines 50, 51 are approximately kept constant. DC/DC converter 52 may be provided in addition to the elements shown in FIGS. 1 and 2, but also may replace some of the elements, for example detection circuit 42 such that in this case SLICs 34 are not put to power sink mode in case of an over-voltage. In further embodiments, DC/DC converter 52 reacts to over-voltages earlier than a corresponding detection circuit like detection circuit 18 or 42, such that SLICs are only put in power sink mode as an auxiliary measure in case the sinking capabilities of DC/DC converter 52 are not sufficient.

The above embodiments are to be regarded only as examples, and various modifications are possible within the spirit and scope of the invention. For example, while in the embodiment of FIG. 2 a transfer circuit comprising a diode bridge is shown, other kinds of transfer circuits, for example transistor based circuits or circuits comprising breakthrough elements like zener diodes may be employed. Furthermore, while illustrative embodiments have been described comprising subscriber line interfaces to interface with communication lines comprising a pair of wires, for example tip line and ring line of telephone lines, other kinds of interface circuits for interfacing with communication lines are also usable. Instead of battery voltages as in the embodiment of FIG. 2, other supply voltages may be used. Furthermore, while in FIG. 2 single capacitors 40, 41 are shown, capacitor banks comprising a plurality of single capacitors may also be used in various embodiments. Further modifications are also possible.

1. An apparatus, comprising:
a detection circuit configured to detect an over-voltage on a conductive line; and
a control circuit configured to control an interface circuit to reduce a voltage on the conductive line in response to the over-voltage, wherein the interface circuit is configured to be coupled with a communication line.

2. The apparatus of claim 1, wherein the conductive line comprises a power supply line of the apparatus, the apparatus further comprising a transfer circuit coupled the communication line and configured to at least partially transfer to the power supply line at least one of the following: an over-voltage on the communication line and an over-current on the communication line.

3. The apparatus of claim 2, wherein the transfer circuit comprises a diode bridge.

4. The apparatus of claim 2, wherein the detection circuit and the interface circuit are each coupled with the power supply line.

5. The apparatus of claim 1, wherein the control circuit is configured to control the interface circuit to couple the conductive line to a reference potential in response to the over-voltage.

6. The apparatus of claim 1, further comprising a DC/DC converter coupled to the conductive line, wherein the control circuit is configured to control the DC/DC converter to reduce the voltage on the conductive line in response to the over-voltage.

7. The apparatus of claim 1, further comprising a switching element controlled by said control circuit and configured to selectively couple the conductive line to a reference potential.

8. The apparatus of claim 1, further comprising a capacitor coupled between the conductive line and a reference potential.

9. An apparatus, comprising:
a plurality of interface circuits each coupled to a respective communication line;
a voltage supply line coupled with said plurality of interface circuits;
a plurality of transfer circuits, one of each transfer circuit being coupled to a respective one of the communication lines and configured to at least partially transfer an over-voltage on the respective communication line to the voltage supply line;
a detection circuit coupled to the voltage supply line and configured to detect an over-voltage on the voltage supply line; and
a control circuit coupled with said detection circuit and configured to control at least one of the interface circuits to couple the voltage supply line to a reference potential in response to the over-voltage on the voltage supply line.

10. The apparatus of claim 9, wherein each of the interface circuits comprises a subscriber line interface circuit.

11. The apparatus of claim 9, wherein each of the transfer circuits comprises a diode bridge.

12. The communication device according to claim 9, wherein at least one of the interface circuits comprises a switch element coupled between the voltage supply line and a reference voltage, a control input of the switch element configured to be controlled by the control circuit.

13. The apparatus of claim 12, wherein the switch element comprises a transistor.

14. The communication device according to claim 9, further comprising a positive temperature coefficient thermistor coupled in series with at least one of the communication lines.

15. The apparatus of claim 9, wherein apparatus is configured as a line card.

16. The apparatus of claim 9, further comprising a capacitor coupled between the voltage supply line and a reference potential.

17. The apparatus of claim 9, wherein the control circuit is configured to control less than all of the interface circuits to couple the voltage supply line to a reference potential in response to the over-voltage on the voltage supply line.

18. A method, comprising:
transferring current from a first conductive line to a second conductive line in response to at least one of an over-voltage and an over-current occurring on the first conductive line;
detecting an over-voltage on the second conductive line, and
reducing a voltage on the second conductive line responsive to detecting the over-voltage on the second conductive line.

19. The method of claim 18, wherein the first conductive line is a communication line.

20. The method of claim 18, wherein reducing comprises coupling the second conductive line to a reference potential.

21. The method of claim 18, wherein reducing comprises controlling a DC/DC converter to reduce the voltage.

22. A method, comprising coupling a voltage supply input of an interface circuit of a communication device to a reference potential in response to at least one of an over-voltage and an over-current occurring in a communication line.

23. The method of claim 22, wherein the reference potential is ground.

24. The method of claim 22, selecting the interface circuit from a plurality of interface circuits depending upon which of the plurality of interface circuits is inactive.

25. The method of claim 22, further comprising diverting current from the communication line to the voltage supply input in response to the at least one of the over-voltage and the over-current in the communication line.
